(19) United States
(12) Patent Application Publication
(10) Pub. No.: US 2018/0051160 A1
(43) Pub. Date: Feb. 22, 2018

(54) Stabilized Balanced Melt Strength and Strain Hardened Polypropylene

(71) Applicant: ExxonMobil Chemical Patents Inc., Baytown, TX (US)

(72) Inventors: George J. Pehlert, Houston, TX (US); Mosha H. Zhao, Houston, TX (US)

(21) Appl. No.: 15/556,182

(22) PCT Filed: Jan. 21, 2016
(86) PCT No.: PCT/US2016/014238

§ 371 Date: Sep. 6, 2017

Related U.S. Application Data
(60) Provisional application No. 62/140,569, filed on Mar. 31, 2015.
(60) Provisional application No. 62/111,802, filed on Feb. 4, 2015.

(51) Int. Cl. C08K 5/14; C08K 5/1545; C08L 23/10; C08L 23/16

(52) U.S. Cl. CPC C08K 5/14; C08K 5/1545; C08K 5/005; C08L 23/16; C08L 23/10

(57) ABSTRACT

A composition comprising the reaction product of a polypropylene comprising at least 50 mol % propylene, and having a molecular weight distribution (Mw/Mn) greater than 6, a branching index (g′) of at least 0.97, and a melt strength greater than 10 cN determined using an extensional rheometer at 190° C.; within the range from 0.01 to 3 wt % of at least one organic peroxide, by weight of the composition; and within the range from 5 to 4000 ppm of at least one alkyl-radical scavenger such as a tocopherol, by weight of the composition, all melt blended at a temperature of at least the melting point temperature of the polypropylene.

### CROSS-REFERENCE TO RELATED APPLICATIONS

The present application claims priority to and the benefit of U.S. Ser. No. 62/111,802 filed Feb. 4, 2015 and U.S. Ser. No. 62/140,569, filed Mar. 31, 2015, both of which are incorporated by reference.

### FIELD OF THE INVENTION

The present disclosure relates to polypropylenes having balanced melt strength and strain hardening and also being stabilized by addition of at least one alkyl-radical scavenger for melt extrusion processes.

### BACKGROUND

Market demand for low cost, low environmental impact, and safe microwavable containers for use in food and other packaging applications represent an opportunity for polypropylene to replace polystyrene. However, common linear polypropylene (“PP”) grades display low melt strength and lack strain hardening behavior needed for foaming A balanced melt strength (“BMS”) polypropylene (see WO 2014/070386) with broad molecular weight distribution has shown some promise in terms of improved melt strength, but its strain hardening could be improved. To expand the applications of BMS PP the inventors have worked towards developing a new PP product with balanced melt strength and strain hardening through a reactive extrusion process that is compatible with common production technologies.

In U.S. Ser. No. 62/111,802 filed on Feb. 4, 2015, the reactive extrusion of an organic peroxide with a BMS polypropylene was disclosed. Different from most other peroxides commonly used for vis-breaking polypropylene where beta-scission is the main reaction step, the class of organic peroxides disclosed therein was found to initiate chain branching and cross-linking in polypropylene at 240° C. and lower temperature. This desirably improved melt strength, as well as the strain hardening of the polypropylene, making it suitable for such applications as forming foamed articles. However, the impact of high temperature extrusion on the polymer itself can be a concern, as well as the impact of other common additives on the final polymer performance.

In WO 2015/200586, vitamin E (α-tocopherol) was combined with a polypropylene, thus “stabilizing” the polypropylene during processing to protect the high molecular weight portion of a BMS PP. The vitamin E was found to have a beneficial effect on the polymer's ability to withstand common processing conditions. What is needed is a polypropylene with balanced melt strength and strain hardening suitable for foamed articles that can easily withstand common processing conditions, compatible with common additives, and be suitable for many end use application such as foamed food containers.

Relevant publications include M. H. Wagner et al., “The strain-hardening behaviour of linear and long-chain-branched polyolefin melts in extensional flows,” in 39 RHEOL. ACTA 97-109 (2000); R. P. Lagendijk et al., in “Peroxydicarbonate modification of polypropylene and extensional flow properties,” in 42 POLYMER 10035-10043 (2001); P. Spitael et al., in “Strain hardening in polypropylenes and its role in extrusion foaming,” in 44(11) POLY. ENG. & SCI. 2090-2100 (2004); K. Jayaraman et al., “Entangling additives enhance polypropylene foam quality,” in SPE PLASTICS RESEARCH ONLINE (2011); P. Iacobucci, “High melt strength polypropylene through reactive extrusion with Perkadox 24L,” SPE POLYOLEFINS CONFERENCE, Houston, Tex. (February 2004); H. Pol et al., “Microstructure and rheology of high-melt-strength poly-(propylene) impact copolymer,” in SPE PLASTICS RESEARCH ONLINE (2014); M. Ratzsch et al., 27 PROG. POLYM. SCI. 27 1195 (2002); and N. Spisakova et al., in 15 J. MACRM. SCI. & APP. CHEM. 37 (2000); EP 2 679 630 A1; EP 2 000 504 A1; U.S. Pat. No. 5,883,151; US 2003/0157286; U.S. Pat. No. 6,875,826; U.S. Pat. No. 6,573,343; WO 1997/49759; WO 1999/27007; WO 1994/005707; and WO 2014/070386.

### SUMMARY

Disclosed is a composition comprising the reaction product at a temperature of at least the melting point temperature of the polypropylene comprising at least 50 mol % propylene, and having a molecular weight distribution (Mw/Mn) greater than 6, a branching index (g′) of at least 0.97, and a melt strength greater than 10 cN determined using an extensional rheometer at 190° C.; within the range from 0.01 wt % to 3 wt % of at least one organic peroxide, by weight of the composition; and within the range from 5 to 4000 ppm of at least one alkyl-radical scavenger.

Also disclosed is a process to form a composition comprising combining a polypropylene comprising at least 50 mol % propylene, and having a molecular weight distribution (Mw/Mn) greater than 6, a branching index (g′) of at least 0.97, and a melt strength greater than 10 cN determined using an extensional rheometer at 190° C.; within the range from 0.01 wt % to 3 wt % of at least one organic peroxide, by weight of the composition; and within the range from 5 to 4000 ppm of at least one alkyl-radical scavenger, the combining occurring at a temperature of at least the melting point temperature of the polypropylene.

### BRIEF DESCRIPTION OF THE DRAWINGS

FIG. 1 is a graph of extensional viscosity as a function of time for BMS PP treated with 1.3 wt % Perkadox at 210° C. in the presence of 150 ppm of vitamin E, from which the Peak Extensional Viscosity at 0.01 s⁻¹ (“PEV”) is determined.

FIG. 2 is a graph of extensional viscosity (Eta* or “ηₑ”) as a function of angular frequency for various treated BMS PPs, wherein each curve reflects a different weight percent of organic peroxide combined with the BMS PP.

FIG. 3 is a graph of the Pull off Force as a function of draw ratio for various amounts of organic peroxide combined with the BMS PP, revealing the draw ratio and the melt strength, also summarized in Table 1.

### DETAILED DESCRIPTION

The inventors have found that the addition of an alkyl-radical scavenger to polypropylene compositions that are also being treated with an organic peroxide show enhanced extensional viscosity, as evidenced by the improved Peak Extensional Viscosity (“PEV”), as well as an improved draw ratio when compared to those treated with the organic peroxide alone, or with standard phosphorous- and phenolic-based antioxidants. This is achieved in any embodiment by a stabilized polypropylene composition which is the reaction product of a balanced melt strength polypropylene, at least one organic peroxide, and at least one alkyl-radical scavenger, desirably at a temperature of at least the melting point of the balanced melt strength polypropylene, such as at least 150° C.

The stabilized polypropylene compositions described herein have several desirable features. In any embodiment, the stabilized polypropylene compositions have an Mx_{MALLS}/Mw_{MALLS} value of greater than 3.0, or 3.2, or 3.6, or within a range from 3.0, or 3.2, or 3.6 to 5.0, or 6.0, or 8.0, or 12, or 16. Also in any embodiment, the stabilized polypropylene compositions have an Mw_{MALLS}/Mn (MWD_{MALLS}) within the range from 10, or 12 to 16, or 20. Also in any embodiment, the stabilized polypropylene compositions have a branching index (g′) of less than 0.97, or 0.95, or 0.90, or within a range from 0.70, or 0.80 to 0.90, or 0.95, or 0.97, indicative of some branching and/or cross-linking of the balanced melt strength polypropylene.

As used throughout the specification, “MALLS” analysis, which is described further in the “Examples”, may be used to measure the molecular weight properties of the polypropylenes described herein, but if not otherwise indicated, DRI analysis is used for molecular weight determinations.

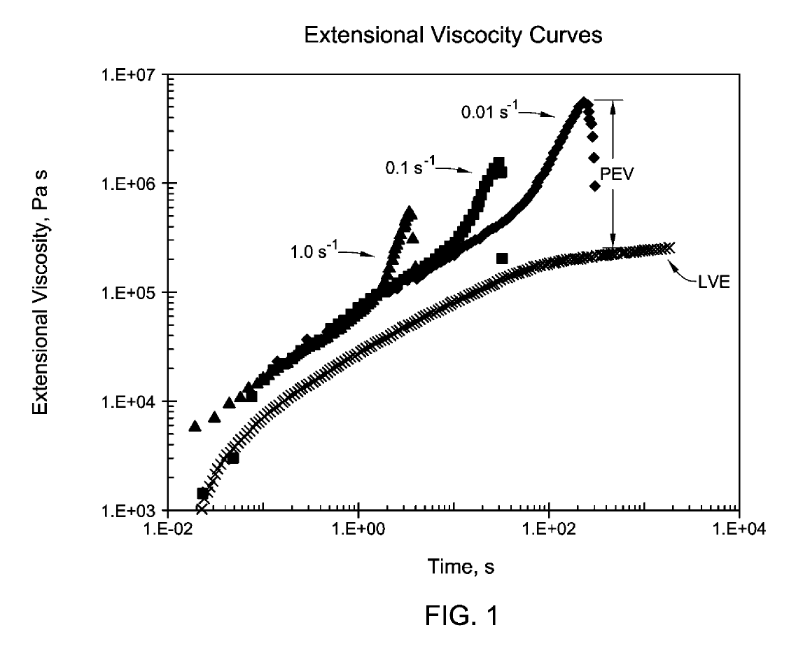

The stabilized polypropylene compositions have improved melt strength and extensional viscosity when compared to the balanced melt strength polypropylenes. In any embodiment the stabilized polypropylene compositions have a melt strength within the range from 45, or 50, or 55 cN to 80, or 85, or 90, or 100 cN. In any embodiment, the stabilized polypropylene has a draw ratio of greater than 4, or 5, or 6, or within a range from 4, or 5, or 5.5 to 8, or 10, or 12. In any embodiment, the stabilized polypropylene compositions have a Peak Extensional Viscosity (annealed) of greater than 500, or 800, or 1000, or 1500, or 2000, or 2200, or 2400, or 2800, or 3000 kPa·s at a strain rate of 0.01 sec⁻¹ (190° C.), or within a range of from 1000, or 1500, or 2000 kPa·s to 5000, or 5500, or 6000, or 6500, or 7000, or 8000 kPa·s. The “Peak Extensional Viscosity” or “PEV” is the difference between the highest value for the extensional viscosity (y-axis in FIG. 1) and the LVE, such as labeled in FIG. 1.

As further evidence of any long chain branching in the organic peroxide-treated balanced melt strength polypropylenes, the melt flow properties were measured. Thus, in any embodiment the stabilized polypropylene compositions have an melt index (I₂, ASTM D1238, 21.6 kg/2.16 kg, 190° C.) value within a range from 0.1, or 0.2, or 0.5 g/10 min to 4, or 5, or 8, or 10 g/10 min; and an I₂₁/I₂ value of greater than 150, or 160, or 170, or within a range from 160, or 170 to 190, or 200, or 220, or 240, or 260.

In any embodiment, in forming the compositions, as the level of organic peroxide is increased, the individual I₂ and I₂₁ values decrease but the I₂₁/I₂ value increases; and most preferably, when forming the stabilized polypropylene compositions, as the level of organic peroxide is increased to a level in the composition above 1.5 wt % by weight of the composition, the I₂₁/I₂ value becomes constant or goes down. By “constant” what is meant is that the value of the I₂₁/I₂ does not vary more than by ±10 or ±15%. Stated another way, the level of peroxide and alkyl-radical scavenger can be adjusted such that the optimal or peak value of I₂₁/I₂ is when the amount of organic peroxide added when forming the compositions described herein is within a range from 1.0, or 1.1 wt % to 1.5, or 1.6, or 1.8 wt %. Thus, in any embodiment of the reaction product and/or method of forming the compositions, a preferred level of organic peroxide is within a range from 1.0, or 1.1 wt % to 1.8, or 2.0, or 2.2 wt % by weight of the composition.

Thus, the disclosure herein also includes a process to form the stabilized polypropylene compositions described herein comprising combining at a temperature of at least 150, or 160, or 180, or 190, or 200, or 210° C. (or within a range from 150, or 160, or 180, or 190° C. to 220, or 230, or 240, or 260, or 280° C.) a balanced melt strength polypropylene as described herein; within the range from 0.01, or 0.1, or 1.0 to 1.5, or 2.0, or 2.5, or 3 wt % of at least one organic peroxide, by weight of the stabilized polypropylene composition; and within the range from 5 to 4000 ppm, or other range as stated herein, of at least one alkyl-radical scavenger.

In any embodiment, the components are dry blended, and most preferably heated while dry blended as described herein, followed by reactive extrusion within the desired temperature to form pellets of the compositions ready for shipping, or directly into articles of manufacture.

The individual components used to form the inventive compositions are described in more detail here, elements of which can be easily interchanged with the description above.

### Balanced Melt Strength Polypropylene

As stated above, the stabilized polypropylene compositions are derived from a polypropylene having certain desirable features, referred to herein simply as a “balanced melt strength polypropylene” (or BMS PP) as described here, made according to the disclosure in WO 2014/070386. In particular, the balanced melt strength polypropylene is preferably produced in a solution or slurry process, most preferably in two or more reactors in series wherein the level of chain-termination agent, such as hydrogen, is the same or within 2, or 5, or 10% of the value from the first to second, third, (each subsequent) etc. reactor, and/or stated another way, wherein the MFR (ASTM D1238, Condition L, 230° C./2.16 kg) of the polypropylene from the first reactor is the same or within 2, or 5, or 10% of the value of the polypropylene from in the second, third, (each subsequent) etc. reactor.

In any embodiment the polypropylene useful in the present disclosure comprises at least 50, or 60, or 70, or 80, or 90 mol % propylene-derived units (or “propylene”), or within a range from 50, or 60, or 80 to 95, or 99 or 100 mol % propylene, the remainder being units derived from a comonomer selected from ethylene and C₄ to C₆, or C₁₀, or C₁₂, or C₂₀ olefins. More preferably, the polypropylene may comprise within the range from 0.1 to 10 mol % of a comonomer selected from the group consisting of ethylene and C₄ to C₆, or C₁₀, or C₁₂, or C₂₀ olefins, the remainder being propylene. Most preferably the polypropylene is a homopolymer of propylene-derived units.

In any embodiment the polypropylene has an isopentad percentage of greater than 90, or 92, or 95%. Also in any embodiment the polypropylene has a melt flow rate (MFR) within the range from 0.1, or 1, or 2 g/10 min to 12, or 16, or 20, or 40 g/10 min, determined according to ASTM D1238 Condition L (230° C./2.16 kg).

In any embodiment the polypropylene has a molecular weight distribution (Mw/Mn) greater than 6, or 8, or 10, or within a range from 6, or 7, or 8 to 14, or 16, or 18 or 20. Also in any embodiment the polypropylene has an Mz/Mw value of less than or equal to 3.6, or 3.4, or 3.2, or 3.0, or within a range from 3.0, or 3.2 to 3.6. The polypropylenes useful in the present disclosure tend to be highly linear as evidenced by a high branching index. Thus, in any embodiment the polypropylene has a branching index (g′ ᵥᵢₛ, also referred to as g′_{vis avg}) of at least 0.97, or 0.98. In any embodiment the polypropylenes useful herein have a melt strength greater than 10, or 15, or 20, or 30 cN determined using an extensional rheometer at 190° C., or within a range from 10, or 15, or 20 cN to 35, or 40 cN.

In any embodiment the polypropylene has a viscosity ratio within the range from 35 to 80 determined from the complex viscosity ratio at 0.01 to 100 rad/s angular frequency at a fixed strain of 10% at 190° C. Also in any embodiment the polypropylene has a Peak Extensional Viscosity (annealed) within a range from 10, or 20 kPa·s to 40, or 50, or 55, or 60 kPa·s at a strain rate of 0.01/sec (190° C.).

In any embodiment the polypropylene has a heat distortion temperature of greater than or equal to 100° C., determined according to ASTM D648 using a load of 0.45 MPa (66 psi). Finally, in any embodiment the polypropylene has a Modulus within the range from 1800, or 2000 MPa to 2400, or 2500 MPa determined according to ASTM D790A on nucleated samples with 0.1% α-nucleating agent.

The polypropylene can be used in any embodiment, such as by combining with other ingredients, in the form of reactor granules and/or flakes, or as extruder-formed pellets.

### Alkyl-Radical Scavenger

The “alkyl radical scavenger” is a compound or combination of compounds selected from hydroxyl amine, hydroxyl amine-containing compounds, lactone, lactone-containing compounds, chromanol, and chromanol-containing compounds and capable of reacting with an alkyl radical compound to render it neutral (no radical centers present). More preferably, the alkyl radical scavenger is selected from 6-chromanol-containing compounds; most preferably, tocopherol and derivatives thereof (e.g., alpha, beta, gamma, delta, and C₁₀ to C₂₆ side chain).

Most preferably, n any embodiment the alkyl-radical scavenger is present in the compositions, or blend used in the process described herein, within a range from 5, or 20, or 50, or 100, or 125, or 130, or 135, or 140 ppm to 160, or 165, or 170, or 175, or 200, or 400, or 800, or 1000, or 2000, or 3000, or 4000 ppm.

Most preferably, the alkyl-radical scavenger is selected from 6-chromanol-containing compounds. A highly desirable compound is selected from tocopherol and derivatives thereof (e.g., alpha, beta, gamma, delta, and C₁₀ to C₂₆ side chain). For example, desirable 6-chromanol-containing compounds can comprise compounds of formula (I):

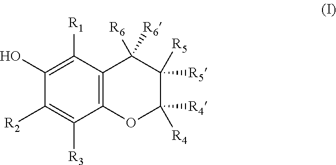

wherein each of R₁, R₂, R₃ and R₆/R₆, are independently selected from hydrogen and C1 to C10 linear alkyls or branched alkyls, most preferably hydrogen and C1 to C5 linear and branched alkyls, and even more preferably, selected from hydrogen and methyl groups; and
each of R₄ and R₅ (and R₄′ and R₅′) are independently selected from hydrogen and C1 to C30 linear or branched alkyls; even more preferably, either one of R₄ or R₅ (and R₄′ and R₅′) are independently selected from C₈ to C₂₄ branched alkyls, and most preferably either one of R₄ or R₅ (and R₄′ and R₅′) are independently selected from C₁₀ to C₂₀ branched alkyls, wherein the other of R₄ or R₅ is hydrogen. For instance, each of R₁, R₂ and R₃ may be methyl groups, while R₅ and R₆ are hydrogens, and R₄ is a branched C₁₆ group, such as the case with α-tocopherol. The stereochemistry at the R₄ carbon is not important and can be a mixture of chiral centers.

The substitutions or branching on the longer R₄ and/or R₅ can be any alkyl group, preferably methyl groups, on at least one carbon along the main carbon chain. A most preferable alkyl-radical scavenger is dl-α-tocopherol and its salts and C₁ to C₃ (any R₁ to R₄, and/or R₆ group) derivatives.

### Organic Peroxides and Methods of Forming Compositions

The stabilized polypropylene compositions, as stated above, are formed by combining under suitable conditions the balanced melt strength polypropylene, at least one alkyl-radical scavenger (and optionally other additives such as phosphorous- or phenolic-based antioxidants), and an organic peroxide, wherein the “organic peroxide” is any organic compound comprising at least one —(O)COO— group and/or —O—O— group, and a 1 hour half-life temperature (¹T_{1/2}) of less than 100° C. determined in an aromatic and/or halogenated aromatic hydrocarbon solvent, preferably a (¹T_{1/2}) within the range from 25, or 35, or 45° C. to 65, or 75, or 85, or 100° C.

In any embodiment, the organic peroxide is selected from compounds having one more structures selected from:

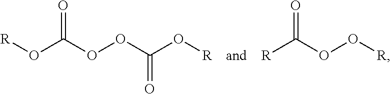

wherein each “R” group is independently selected from the group consisting of hydrogen, C1 to C24 linear alkyls, C1 to C24 secondary alkyls, C1 to C24 tertiary alkyls, C7 to C30 alkylaryls, C7 to C30 arylalkyls, and substituted versions thereof. By “substituted” what is meant are hydrocarbon “R” groups having substituents such as halogens, carboxylates, hydroxy, amines, mercaptans, and phosphorous containing groups. In a particular embodiment, each “R” group is independently selected from C8 to C20 linear, secondary, or tertiary alkyls.

In any case, it is also preferable if the organic peroxide is blended with the balanced melt strength polypropylene, or “combined”, such that it evenly coats the balanced melt strength polypropylene to effect the cross-linking reaction. In any embodiment, reactor granules of the balanced melt strength polypropylene used herein are preferred over extruded pellets. Such balanced melt strength polypropylene granules, flakes or pellets are preferably dry blended with the organic peroxide before “combining” in a reactive extrusion process as described below, with or without alkyl-radical scavenger. This can take place in any type of dry blending apparatus that can blend the ingredients, and preferably mix and/or stir them to enhance contact between the ingredients. In any embodiment the balanced melt strength polypropylene, in whatever form, may be heated up to below its melting point temperature prior to or concurrently with dry blending with the organic peroxide, for instance, to a temperature within a range from 60, or 70, or 80, or 100, or 110, or 120° C. up to the melting point temperature, such as 150, or 155, or 160° C. In any embodiment, the organic peroxide and BMS PP are combined at such an elevated temperature for 10 sec, or 30, sec, or 1 min up to 5 min, or 10 min, or 30 min prior to melt extrusion as described below.

The formation of the stabilized polypropylene compositions described herein are effected in any embodiment by “combining” the ingredients in a reactive extrusion process, for example such as a melt blending or melt extrusion process where shear forces and applied radiative heating are present to cause intimate mixing of the ingredients and effecting the desired chemical reaction. In any embodiment the ingredients are combined to a melt temperature of at least the melting point of the balanced melt strength polypropylene, such as at least 140, or 150, or 160, or 180° C., or within a range from 150, or 160° C. to 180, or 200, or 220, or 240, or 260, or 280, or 300° C. In any embodiment the stabilized polypropylene compositions, directly from the extrusion process, are formed into reactor flakes and/or granules, or extruded pellets without being treated under vacuum and/or solvent washing.

Thus formed, the stabilized polypropylene composition described herein is ready to ship, transport, and/or store without further treatment, and be used in making any number of articles, both foamed and non-foamed. In any embodiment a foaming agent may be added during the heating/extrusion process described above such that the agent is not activated until after shipping and ready to form into a foamed article. As mentioned, the composition may be later heated/extruded again to form articles and effect foaming, if so desired.

As mentioned, the stabilized polypropylene compositions may further comprise a foaming agent as is known in the art to effect the formation of air containing pockets or cells within the composition.

In any embodiment, other “additives” may also be present in the compositions as is known in the art, in any embodiment up to 1, or 2, or 3 wt % by weight of the compositions described herein. Such additives include antioxidants (e.g., hindered phenol- and phosphite-type compounds), nucleators, colorants (dyes, pigments, etc.), fillers (silica, talc, etc.), UV stabilizers, release agents, tackifiers, anti-static agents, acid scavengers (e.g., calcium stearate), anti-blocking agents, anti-blooming agents, and other common additives as is known in the art. In a preferred embodiment, even when the compositions described herein “consist of” the named components, the composition may nonetheless include up to 4000 ppm of one or more antioxidants, or up to 4000 ppm of each of antioxidants (one or more) and foaming agents (one or more).

In any embodiment, so called “dienes” such as C3 to C20 α-olefins, olefins, diolefins, and conjugated dienes, such as, for example, butadiene, are substantially absent from the balanced melt strength polypropylene and/or the stabilized polypropylene compositions described herein, meaning that if the comonomers are present at all, they are present to a level of less than 1 wt %, 0.1 wt %, or 0.01 wt % of the resin or composition.

Finally, in any embodiment “cross-linking agents” are absent from the hyperbranched polypropylenes and not added during the process of making them, and most preferably absent from compositions including the hyperbranched polypropylenes and not added during the process of making them. So called “cross-linking agents” are agents that effect chemical bonding between or within polymer chains through two or more active moieties on the agent, each of which can react with a distinct section of the same polymer chain and/or two different polymer chains. Such agents include diene compounds as described above such as butadiene, polybutadiene, alpha-omega dienes such as 1,9-decadiene, and also compounds such as alkyl-cyanurates and alkyl isocyanurates, especially tri(alkyl allyl) cyanurates and tri(alkyl allyl)isocyanurates, glycol dimethacrylates, alkylene-bisacrylamides, imidoesters, hydroxysuccinamides, mercaptans compounds, sulfide compounds, persulfate compounds, azo compounds, and silane compounds, and other combination compounds such as, for example, bis(triethoxysilylpropyl)tetrasulfide.

The stabilized polypropylene compositions have certain desirable features that make processing into pellets and/or articles of manufacture ideal. In any embodiment, a step of exposing the compositions to external radiation (e.g., gamma rays, microwaves, electron beams, neutron beams) is absent at all stages of manufacturing. The term “external radiation” refers to man-made sources of radiation and excludes natural background radiation and/or sunlight. Most preferably, the stabilized polypropylene composition is not heated after melt extrusion to form the stabilized polypropylene composition. Thus, once the granules or pellets are isolated, there is no need to heat or otherwise irradiate the granules or pellets to effect any other change to alter its properties (e.g., activating a cross-linking agent, etc.). Thus, forming an article of manufacture from the stabilized polypropylenes may consist essentially of, or consist of, forming pellets of the stabilized polypropylenes, then performing melt extrusion in a thermoforming or foaming apparatus to form thermoformed articles or foamed articles.

Also, in any embodiment the stabilized polypropylene compositions comprise minimal side products from the process to form them, most preferably comprising decomposition products comprise (or consisting of) carbon dioxide and/or alcohol, especially alcohols having a lower molecular weight than the organic peroxide used to form the composition, most preferably C10 to C20 or C30 alcohols.

In any embodiment also included is the reaction product of the foaming agent and stabilized polypropylene composition. This reaction product may be formed into any number of suitable foamed articles such as cups, plates, other food containing items, and food storage boxes, toys, handle grips, and other articles of manufacture.

The various descriptive elements and numerical ranges disclosed herein for the stabilized polypropylene compositions and methods of forming such can be combined with other descriptive elements and numerical ranges to describe the stabilized polypropylene compositions; further, for a given element, any upper numerical limit can be combined with any lower numerical limit described herein, including the examples in jurisdictions that allow such combinations. The features of the stabilized polypropylene compositions are demonstrated in the following non-limiting examples.

### EXAMPLES

The crystallization and melting point temperatures of balanced melt strength polypropylenes and compositions were determined by Differential Scanning calorimetry at 10° C./min on a Pyris™ 1 DSC. The DSC ramp rate is 10° C./min for both heating and cooling. The measurements are taken as follows: 1) Hold for 10.0 min at −20.0° C.; 2) Heat from —20.0° C. to 200.0° C. at 10.0° C./min; 3) Hold for 10.0 min at 200.0° C.; 4) Cool from 200.0° C. to −20.0° C. at 10.0° C./min; 5) Hold for 10.0 min at -20.0° C.; and 6) Heat from −20.0° C. to 200.0° C. at 10.0° C./min

The high load melt index (I₂₁ or HLMI) parameters were determined per ASTM D1238, at 190° C., 21.6 kg; the melt index at 190° C., 2.16 kg. The Melt Flow Rates (MFR) were determined under Condition L, at 230° C., 2.16 kg.

Polymer molecular weight (weight-average molecular weight, Mw, number-average molecular weight, Mn, and z-averaged molecular weight, Mz) and molecular weight distribution (Mw/Mn) are determined using Size-Exclusion Chromatography. Equipment consists of a High Temperature Size Exclusion Chromatograph (either from Waters Corporation or Polymer Laboratories), with a differential refractive index detector (DRI), an online light scattering detector, and a viscometer (SEC-DRI-LS-VIS), and also a Multi-Angle Light Scattering detector (MALLS), where mono-dispersed polystyrene is the standard in all cases. The Mark-Houwink constants used were K=0.000229, and a=0.705. Three Polymer Laboratories PLgel 10 mm Mixed-B columns are used. The nominal flow rate is 0.5 cm³/min and the nominal injection volume is 300 μL. The various transfer lines, columns and differential refractometer (the DRI detector) are contained in an oven maintained at 135° C. Solvent for the SEC experiment is prepared by dissolving 6 grams of butylated hydroxy toluene as an antioxidant in 4 liters of reagent grade 1,2,4-trichlorobenzene (TCB). The TCB mixture is then filtered through a 0.7 um glass pre-filter and subsequently through a 0.1 μm Teflon filter. The TCB is then degassed with an online degasser before entering the SEC. MALLS analysis is relied upon for Mw and Mz when calculating, for example, Mw/Mn, or Mz/Mn for the hyperbranched polypropylene, which is a more accurate method for measuring highly branched polymers, while DRI values are used for Mn, which is more sensitive and detects smaller molecules. For purposes of the claims and specification, SEC-DRI shall be used unless otherwise specified.

The branching index (g′ᵥᵢₛ, also referred to as g′_{vis avg}) is calculated using the output of the SEC-DRI-LS-VIS method (described in U.S. Pat. No. 7,807,769), and as described in WO 2014/070386.

### Sheer Thinning and Strain Hardening

A MCR501 Dynamic Stress/Strain Rheometer was used to measure sheer thinning of the polypropylene samples. A TA Instruments ARES-G2 mechanical spectrometer was used to measure strain hardening of the polypropylene samples.

### Sample Preparation:

It was observed that some of the melted samples could collapse before testing. There are two ways to prepare the samples:

Not annealed method: A sample was heated to around 200° C. for 3 min to melt the PP pellets without pressure. Then 1500 psi pressure was applied while the sample was kept heated for another 3 min between two plates. Afterwards, still under the 1500 psi pressure, the sample was cooled down with water circulation for 3 min.

Annealed method: A sample was heated to around 200° C. for 3 min to melt the PP pellets without pressure. Then 1500 psi pressure was applied while the sample was kept heated for another 3 min between two plates. Afterwards, the pressure applied to sample was removed while the sample was kept heated at 200° C. for another 20 min After 20 min, the sample was cooled down with water circulation without any pressure applied for additional 20 min. In the experiments described herein, all samples were annealed.

### Testing Temperature:

The temperature can vary from 120° C. to 190° C. for extensional but was set 190° C. for PP testing. As for the Hencky strain rate in extensional, it was run at 0.01s⁻¹, 0.1s⁻¹ and 1.0s⁻¹.

### Melt Strength and Elongational Viscosity

The method used to measure the melt strength and elongational viscosity using the Rheotester 1000 capillary rheometer in combination with the Rheotens 71.97 (Gottfert) is described in established test method RHE04-3.3 (“Measurement of the elongational viscosity of molten polymers”).

### A. Test Conditions:

The conditions for testing melt strength/extensional viscosity using the Rheotens 71-97 in combination with the Rheotester 1000 are described in RHEO4-3.3:

### 1. Rheotester 1000:

Temperature: 190° C.
Die: 30/2
Piston speed: 0.278 mm/s
Shear rate: 40.050 sec⁻¹

### 2. Strand:

Length: 100 mm
Vo: 10 mm/s

### 3. Rheotens:

Gap: 0.7 mm
Wheels: grooved
Acceleration: 12.0 mm/s²

### B. Testing:

For each material, several measurements are performed. In fact, the complete amount of material present in the barrel of the Rheotester was extruded through the die and was being picked up by the rolls of the Rheotens. Once the strand was placed between the rolls, the roll speed was adjusted until a force of “zero” was measured. This beginning speed “Vs” was the speed of the strand through the nip of the wheels at the start of the test.

Once the test was started, the speed of the rolls was increased with a 12.0 mm/s² acceleration and the force was measured for each given speed. After each strand break, or strand slip between the rotors, the measurement was stopped and the material was placed back between the rolls for a new measurement. A new curve was recorded. Measuring continued until all material in the barrel was used.

### C. Data Treatment:

After testing, all the obtained curves are saved. Curves which are out of line are deactivated. The remaining curves, are cut at the same point at break or slip (maximum force measured), and are used for the calculation of a mean curve. The numerical data of this calculated mean curves are reported.

Experiments were conducted to test the strain hardening, shear thinning and melt strength of BMS PP treated as described herein, and it was found that the addition of vitamin E maintained or improved the properties of the composition. The starting balanced melt strength polypropylene was a Ziegler-Natta produced homopolymer having an I₂ of 3.1 g/10 min, an I₂₁ of 352 g/10 min, a Mz/Mw (DRI) of 2.9, and a melt strength of 22.2 cN. Also, the starting balanced melt strength polypropylene used in the examples have a Mw/Mn (MWD, by DRI) of 8.4, an Mn value of 41,300 g/mol, an Mw value of 347,400 g/mole, and an Mz value of 1,100,000 g/mole. The organic peroxide, Perkadox 24L™ (Akzo-Nobel, with a half-life of 30 min at 84° C.), was dry-tumble blended with vitamin E (α-tocopherol) and all other additives with the balanced melt strength polypropylene granules at room temperature. In the studies, different levels of Perkadox 24L, together with 2000 ppm of Irganox™ 1010, 2000 ppm of Irgafos™ 168 and 500 ppm of CaSt, were added in comparison experiments. All the samples were extruded in a ZSK 30mm twin screw extruder at 210° C. (while testing was performed at 190° C.). The MFR testing results are consistent with later rheology testing results, as summarized in Table 1.

TABLE 1
Melt Blending of BMS PP and Perkadox at 210° C.

| | | | | | Peak extensional | | |
|---|---|---|---|---|---|---|---|
| | 150 ppm | | | | viscosity at | Melt | |
| Perkadox 24 L | vitamin E | | | | 0.01 s⁻¹ (PEV) | Strength | |
| (wt %) | added | I₂ | I₂₁ | I₂₁/I₂ | (kPa · s) | (cN) | Draw Ratio |
| 0 | — | 3.1 | 352 | 112 | 24.8 | 22.2 | 3.6 |
| 0.3 | — | 2.1 | 304 | 148 | 485.1 | 20.7 | 4.4 |
| 0.5 | — | 2.3 | 296 | 131 | 885.1 | 22.7 | 4.5 |
| 1.3* | — | 3.4 | 380 | 112 | — | — | — |
| 2 | — | 1.2 | 191 | 158 | 2,082.9 | 48.8 | 5.2 |
| 1.3 | Yes | 0.9 | 162 | 186 | 5,159.2 | 55.8 | 5.5 |

*problems with this run due to impurities in the extruder caused this trial to fail.

The rheology test was performed on the material to test strain hardening, shear thinning and melt strength. As shown in FIG. 1 and Table 1, the highest extensional viscosity, which is correlated to the strain hardening effect reached the highest level when the balanced melt strength polypropylene was extruded with 1.3 wt % of Perkadox 24 L with vitamin E added. There was one exceptional experiment obtained for 1.3 wt % Perkadox 24 L without vitamin E which was possibly contaminated during the compounding process. All the testing results for that single data point are inconsistent from the rest.

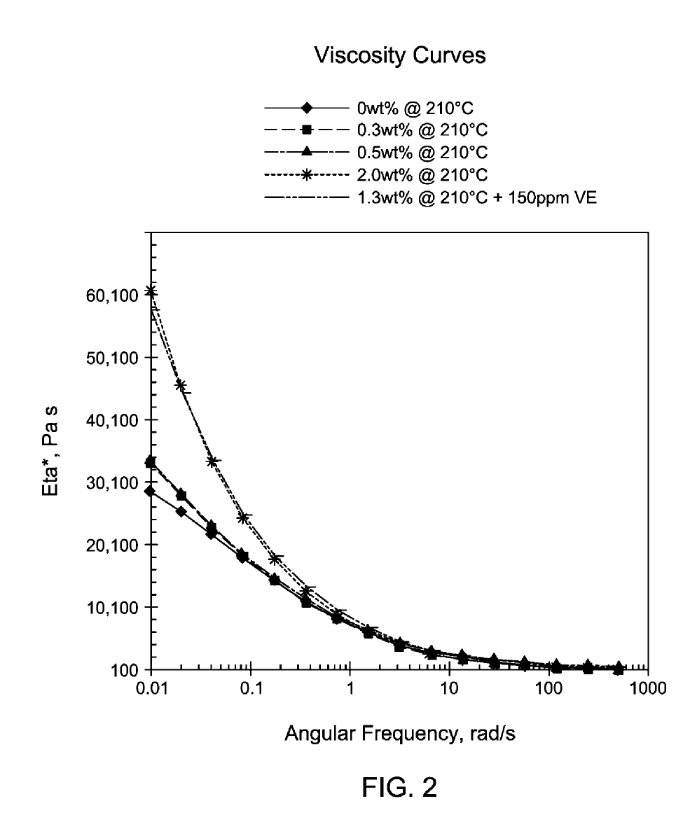

The viscosity curves, an example of which is in FIG. 2, from rheology testing are consistent with the MFR I₂₁/I₂ observations. Balanced melt strength polypropylene was extruded with 1.3 wt % of Perkadox 24 L at 210° C. with vitamin E also has the steepest and highest Eta* curve which represents the most shear thinning This effect is even stronger than without Vitamin E, but only with Perkadox 24 L at 2 wt %.

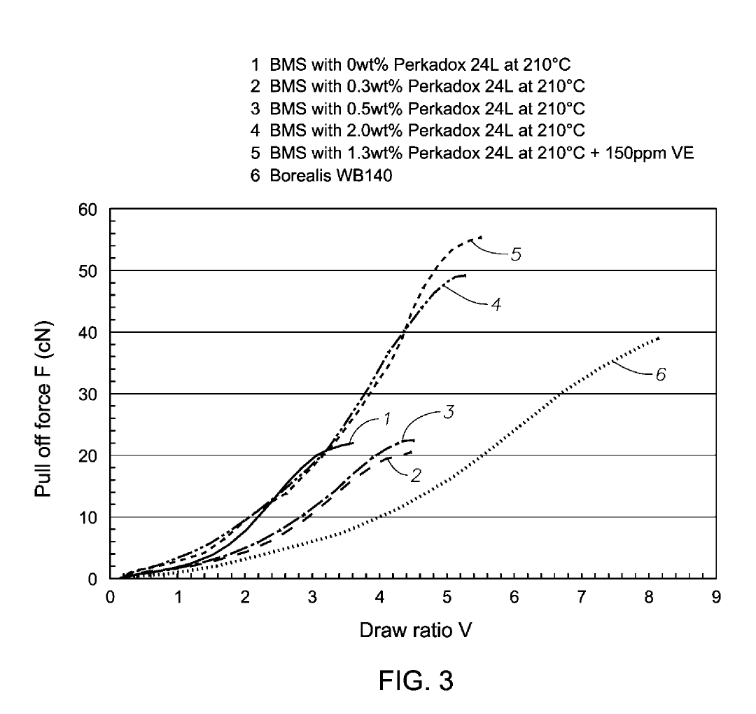

The balanced melt strength polypropylene extruded with 1.3 wt % of Perkadox 24 L with vitamin E also has the highest melt strength and a draw ratio (an indication of extensional flow capability), as shown in FIG. 3 and in Table 1.

Having described all the features of the inventive stabilized polypropylene compositions and methods of forming them, described here in numbered paragraphs is:

P1. A composition comprising (or consisting essentially of, or consisting of) the reaction product of:

a polypropylene comprising at least 50 mol % propylene, and having a molecular weight distribution (Mw/Mn) greater than 6, a branching index (g′) of at least 0.97, and a melt strength greater than 10 cN determined using an extensional rheometer at 190° C.;

within the range from 0.01 to 3 wt % of at least one organic peroxide, by weight of the composition; and

within the range from 5 to 4000 ppm of at least one alkyl-radical scavenger;

wherein the reaction occurs at a temperature of at least the melting point temperature of the polypropylene.

P2. A process to form a composition comprising (or consisting essentially of, or consisting of) combining:

a polypropylene comprising at least 50 mol % propylene, and having a molecular weight distribution (Mw/Mn) greater than 6, a branching index (g′) of at least 0.97, and a melt strength greater than 10 cN determined using an extensional rheometer at 190° C.;

within the range from 0.01 wt % to 3 wt % of at least one organic peroxide, by weight of the composition; and

within the range from 5 to 4000 ppm of at least one alkyl-radical scavenger; the components combined at a temperature of at least the melting point temperature of the polypropylene.

P3. The composition of numbered paragraph 1, or process numbered paragraph 2, wherein the polypropylene has an MWD (Mw/Mn) within the range from 6 to 18.
P4. The composition or process of any one of the previous numbered paragraphs, wherein the polypropylene has a melt strength within the range from 10 cN to 40 cN.
P5. The composition or process of any one of the previous numbered paragraphs, wherein the polypropylene has a Peak Extensional Viscosity (annealed) within a range from 15 kPa·s to 60 kPa·s at a strain rate of 0.01 sec⁻¹ (190° C.).
P6. The composition or process of any one of the previous numbered paragraphs, wherein the polypropylene comprises at least 90 mol % propylene.
P7. The composition or process of any one of the previous numbered paragraphs, wherein the polypropylene has an isopentad percentage of greater than 90%.
P8. The composition or process of any one of the previous numbered paragraphs, wherein the polypropylene has a melt flow rate (MFR) within the range from 0.1 to 100 g/10 min, determined according to ASTM D1238 Condition L (230° C./2.16 kg).
P9. The composition or process of any one of the previous numbered paragraphs, wherein the polypropylene has an Mz/Mw value of less than 3.6.
P10. The composition or process of any one of the previous numbered paragraphs, wherein the polypropylene has a Modulus within the range from 1800 MPa to 2500 MPa determined according to ASTM D790A on nucleated samples with 0.1% α-nucleating agent.
P11. The composition or process of any one of the previous numbered paragraphs, wherein the organic peroxide is selected from compounds having structure(s) selected from:

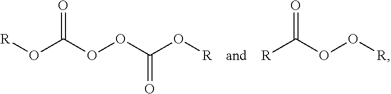

wherein each “R” group is independently selected from the group consisting of hydrogen, C1 to C24 linear alkyls, C1 to C24 secondary alkyls, C1 to C24 tertiary alkyls, C7 to C30 alkylaryls, C7 to C30 arylalkyls, and substituted versions thereof.

P12. The composition or process of numbered paragraph 11, wherein each “R” group is independently selected from C8 to C20 linear, secondary, or tertiary alkyls.
P13. The composition or process of any one of the previous numbered paragraphs, wherein the organic peroxide has a half-life within the range from 0.10 seconds to 60 minutes at 100° C.
P14. The composition or process of any one of the previous numbered paragraphs, the composition having an Mz_{MALLS}/Mw_{MALLS} value of greater than 3.0.
P15. The composition or process of any one of the previous numbered paragraphs, the composition having an MWD_{MALLS} within the range from 10 to 20.
P16. The composition or process of any one of the previous numbered paragraphs, the composition having a branching index (g′) of less than 0.97.
P17. The composition or process of any one of the previous numbered paragraphs, the composition having a Melt Strength within the range from 45 cN to 100 cN.
P18. The composition or process of any one of the previous numbered paragraphs, the composition having a Peak Extensional Viscosity (annealed) of greater than 500 kPa·s at a strain rate of 0.01 sec⁻¹ (190° C.).
P19. The composition or process of any one of the previous numbered paragraphs, the composition having an I₂₁/I₂ value of greater than 150.
P20. The composition or process of any one of the previous numbered paragraphs, comprising carbon dioxide and alcohol.
P21. The composition or process of any one of the previous numbered paragraphs, further comprising a foaming agent.
P22. A foamed article comprising the reaction product of the foaming agent and composition according to, or made according to, any one of the previous numbered paragraphs.
P23. The foamed article of numbered paragraph 22, the article selected from the group of cups, plates, and food storage boxes.
P24. The composition or process of any one of the previous numbered paragraphs, further comprising, prior to combining the components, dry-blending the components, preferably while heating the components to below the melting point temperature of the polypropylene.
P25. The composition or process of any one of the previous numbered paragraphs, wherein a step of exposing the composition to external radiation is absent at all stages of manufacturing.
P26. The composition, articles or process of any one of the previous numbered paragraphs, wherein dienes are not added; or are not present in the composition or article.

Also disclosed is the use of a alkyl-radical scavenger in a composition comprising the reaction product of an organic peroxide and a balanced melt strength polypropylene.

Also disclosed is the use of a reaction product between a alkyl-radical scavenger, a balanced melt strength polypropylene, and an organic peroxide in a foamed article.

The phrase “consisting essentially of” in a composition means that no other additives are present in the composition being referred to other than those named, or, if present, are present to a level no greater than 0.5, or 1.0, or 2.0, or 4.0 wt % by weight of the composition; and in a process, “consisting essentially of” means that no other major process step is present that effects the formation of covalent chemical bonds between two or more moieties, such as application of external radiation, addition of cross-linking agents, etc.

For all jurisdictions in which the doctrine of “incorporation by reference” applies, all of the test methods, patent publications, patents and reference articles are hereby incorporated by reference either in their entirety or for the relevant portion for which they are referenced.

1. A composition comprising the reaction product of:
a polypropylene comprising at least 50 mol % propylene, and having a molecular weight distribution (Mw/Mn) greater than 6, a branching index (g′) of at least 0.97, and a melt strength greater than 10 cN determined using an extensional rheometer at 190° C.;
within the range from 0.01 to 3 wt % of at least one organic peroxide, by weight of the composition; and
within the range from 5 to 4000 ppm of at least one alkyl-radical scavenger;
wherein the reaction occurs at a temperature of at least the melting point temperature of the polypropylene.

2. (canceled)

3. The composition of claim 1, wherein the polypropylene has an MWD (Mw/Mn) within the range from 6 to 18.

4. The composition of claim 1, wherein the polypropylene has a melt strength within the range from 10 cN to 40 cN.

5. The composition of claim 1, wherein the polypropylene has a Peak Extensional Viscosity (annealed) within a range from 15 kPa·s to 60 kPa·s at a strain rate of 0.01 sec⁻¹ (190° C.).

6. The composition of claim 1, wherein the polypropylene comprises at least 90 mol % propylene.

7. The composition of claim 1, wherein the polypropylene has an isopentad percentage of greater than 90%.

8. The composition of claim 1, wherein the polypropylene has a melt flow rate (MFR) within the range from 0.1 to 100 g/10 min, determined according to ASTM D1238 Condition L (230° C./2.16 kg).

9. The composition of claim 1, wherein the polypropylene has an Mz/Mw value of less than 3.6.

10. The composition of claim 1, wherein the polypropylene has a Modulus within the range from 1800 MPa to 2500 MPa determined according to ASTM D790A on nucleated samples with 0.1% α-nucleating agent.

11. The composition of claim 1, wherein the organic peroxide is selected from compounds having structure(s) selected from: 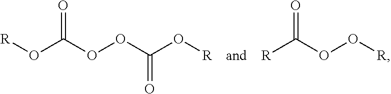
wherein each “R” group is independently selected from the group consisting of hydrogen, C1 to C24 linear alkyls, C1 to C24 secondary alkyls, C1 to C24 tertiary alkyls, C7 to C30 alkylaryls, C7 to C30 arylalkyls, and substituted versions thereof.

12. The composition of claim 11, wherein each “R” group is independently selected from C8 to C20 linear, secondary, or tertiary alkyls.

13. The composition of claim 1, wherein the organic peroxide has a half-life within the range from 0.10 seconds to 60 minutes at 100° C.

14. The composition of claim 1, the composition having an Mz_{MALLS}/Mw_{MALLS} value of greater than 3.0.

15. The composition of claim 1, the composition having an MWD_{MALLS} within the range from 10 to 20.

16. The composition of claim 1, the composition having a branching index (g′) of less than 0.97.

17. The composition of claim 1, the composition having a Melt Strength within the range from 45 cN to 100 cN.

18. The composition of claim 1, the composition having a Peak Extensional Viscosity (annealed) of greater than 500 kPa·s at a strain rate of 0.01 sec⁻¹ (190° C.).

19. The composition of claim 1, the composition having an I₂₁/I₂ value of greater than 150.

20. The composition of claim 1, comprising carbon dioxide and alcohol.

21. The composition of claim 1, further comprising a foaming agent.

22. A foamed article comprising the reaction product of the foaming agent and composition according to claim 21.

23. The foamed article of claim 22, the article selected from the group of cups, plates, and food storage boxes.

24. (canceled)

25. (canceled)

26. A process to form a composition comprising combining:
a polypropylene comprising at least 50 mol % propylene, and having a molecular weight distribution (Mw/Mn) greater than 6, a branching index (g′) of at least 0.97, and a melt strength greater than 10 cN determined using an extensional rheometer at 190° C.;
within the range from 0.01 wt % to 3 wt % of at least one organic peroxide, by weight of the composition; and
within the range from 5 to 4000 ppm of at least one alkyl-radical scavenger;
the components combined at a temperature of at least the melting point temperature of the polypropylene.

27. The process of claim 26, comprising, prior to combining the components, dry-blending the components.

28. The process of claim 26 wherein a step of exposing the composition to external radiation is absent at all stages of manufacturing.
